(19) United States
(12) Patent Application Publication
(10) Pub. No.: US 2011/0217493 A1
(43) Pub. Date: Sep. 8, 2011

(54) Method and Product for Protecting and Extending the Life of Hydrant Markers

(76) Inventor: Philip R. Cowen, New York, NY (US)

(21) Appl. No.: 12/718,195

(22) Filed: Mar. 5, 2010

(51) Int. Cl. B65B 53/02; B29C 65/02; B32B 9/04; B32B 27/36; B32B 27/32; B32B 27/40; B32B 27/30; B32B 27/38

(52) U.S. Cl. 428/34.9; 156/85; 428/411.1; 428/480; 428/523; 428/423.1; 428/521; 428/413

(57) ABSTRACT

The present invention provides weather-, sunlight-, and use-protected hydrant markers, and methods of protecting and extending the useful life of hydrant markers by protecting them against weather, sunlight, and use, through the application of a heat shrinkable material onto the marker.

The ability of firefighting crews to be able to quickly locate fire hydrants during an emergency cannot be understated. Fire hydrant markers are crucial in assisting firefighting crews with locating fire hydrants because it is difficult and often impossible to locate a fire hydrant when it is located in tall undergrowth or obstructed by piles of snow, bushes, illegally-parked cars or trucks, or other obstacles.

Hydrant markers are expected to be long-lasting and virtually maintenance-free; however, they are often made out of fiberglass, which degrades over time and gives off hazardous splinters. Once they are placed in the desired location, the markers should remain intact and functional, as continually checking on the condition of the markers can become burdensome. However, because of their constant exposure to elements such as snow, wind, rain, sunlight, and micro-organisms, ensuring that hydrant markers retain the integrity of their original characteristics can be a difficult task. Steel markers may develop rust. Not only is rust corrosive and unsightly, but also dangerous, as its rough surface serves as a prime habitat for C. tetani, the micro-organism that causes tetanus. Wooden markers may degrade over time due to wood decay fungi and other similar microorganisms that cause wood decay, and chemical treatments aimed at preventing such decay are often not environmentally friendly. Plastic markers may degrade over time due to over-exposure to the ultraviolet (UV) rays of the sun. Fiberglass markers may also degrade and erode over time, giving off hazardous splinters.

In addition to retaining structural integrity, hydrant markers must also be capable of retaining visual integrity. Markers must be readily visible even if partly obstructed. For example, hydrant markers should not only be tall enough to be seen above obstructions, but also be reflective or brightly-colored so that they may be seen in low-light situations. But because markers are outside, they are vulnerable to color degradation from the sun's ultraviolet rays and thus may not maintain the colors they need in order to remain functional.

Currently, the only option for resolving these problems has been to utilize paints or reflective tape. However paints and reflective tape are not very durable, are burdensome to apply, may contain hazardous materials, may not be fade resistant, and often do not cover the entire marker. Thus, there remains a need to provide durable protection of the structural integrity of hydrant markers while simultaneously maintaining colors of such markers. The hydrant markers and methods of the present invention address these issues by reducing the need for constant repair, maintenance, and replacement of markers.

### OBJECTS AND SUMMARY OF THE INVENTION

It is an object of the present invention to provide a method of repairing and/or protecting and extending the life of hydrant markers comprising (a) contacting at least a portion of marker with a heat shrinkable material and (b) applying an effective amount of heat to the heat shrinkable material to shrink the heat shrinkable material onto the hydrant marker, while maintaining the integrity of the hydrant marker.

It is an object of the present invention to provide hydrant markers that have been repaired or protected using the methods described herein.

In preferred embodiments, the method of the present invention further comprises applying a suitable adhesive onto either the hydrant marker in contact with the heat shrinkable material, or the heat shrinkable material prior to contacting the hydrant marker with the heat shrinkable material.

In certain embodiments of the present invention, the excess heat shrinkable material remaining after the heat shrinkable material has shrunken onto the hydrant marker is trimmed away.

In certain embodiments of the present invention, the heat shrinkable material is a flat sheet, tape or tubing. In most preferred embodiments, the heat shrinkable material is tubing.

In preferred embodiments, the heat shrinkable material is from about 0.030 inches to about 0.100 inches thick after recovery and more preferably from about 0.030 to about 0.050 inches thick.

In certain embodiments of the present invention, the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures or variations thereof. In preferred embodiments, the heat shrinkable material comprises polyvinyl chloride.

In certain embodiments of the present invention, the heat shrinkable material comprises at least one additive selected from the group consisting of a colorant, a tackifier, a filler, a plasticizer, a processing oil, an antimicrobial agent, a UV curing agent, a magnetic/magnetisable material and mixtures thereof.

In preferred embodiments, the heat shrinkable material shrinks onto the hydrant marker when the material reaches a temperature from about 85° C. to about 200° C. In more preferred embodiments, the heat shrinkable material shrinks at about 100° C.

In certain embodiments of the present invention, the hydrant marker comprises wood, steel, plastic, fiberglass, or aluminum.

In certain embodiments of the present invention, the hydrant marker is elongated, square, U-channel shaped, rod-shaped, or round.

For purposes of the present invention, the terms “fire hydrant marker,” “hydrant marker,” and “marker” are used interchangeably and include, but are not limited to, hydrant markers made of wood, steel, aluminum, plastic, fiberglass, and other materials known in the art of which hydrant markers are typically constructed.

For the purposes of the present invention, the term “recovered” or “recovery” refers to the stage of the heat shrinkable material after it has undergone shrinkage by a heat source.

For the purposes of the present invention, the phrase “fully recovered” refers to heat shrinkable material that has undergone maximum shrinkage.

For the purposes of the present invention, the phrase “partially recovered” refers to heat shrinkable material that has not undergone maximum shrinkage.

For purposes of the present invention, the phrase “protective covering” refers to the heat shrinkable material after it has shrunken onto the hydrant marker.

### DETAILED DESCRIPTION

As disclosed above, the present invention provides for a method of repairing or protecting and extending the useful life of hydrant markers. The hydrant marker of the present invention is covered with a heat shrinkable material which protects the covered portions of the marker, thus minimizing the maintenance issues commonly associated with such markers after exposure to the elements, e.g. rusting, rotting, degrading, splintering, faded colors, dirt, scratches, and nicks.

The present invention may be employed to protect any type of hydrant marker which requires protection from the elements and/or requires special coloring. Such hydrant marker may be made of any suitable material, such as steel, wood, plastic, fiberglass, and aluminum.

The method of the present invention comprises contacting suitable hydrant markers with a heat shrinkable material and applying heat to the heat shrinkable material to shrink the heat shrinkable material onto the hydrant marker. The heat is applied at an appropriate temperature to allow for the heat shrinkable material to adhere to the hydrant marker, while still maintaining the structural and visual integrity of the hydrant marker.

The method of the present invention provides a rugged, tight-fitting, hazard resistant protective covering which, in certain embodiments, also provides protection against ultraviolet light. In addition to these advantages, the heat shrinkable material is also easy to apply and can be used by virtually anyone with minimal instruction, and can be applied to a variety of materials, including for example steel, wood, plastic, fiberglass, and aluminum.

A further advantage of the present invention is that, in certain embodiments, the shrunken heat shrinkable material may be removed from the hydrant marker. For example, a shallow incision may be made into the shrunken heat shrinkable material which was previously shrunken on the marker, and the shrunken material may then be peeled off of the hydrant marker. This allows for easy replacement of the shrunken heat shrinkable material, if, for example, the user wishes to alter the color of the hydrant marker.

The heat shrinkable material used in the present invention may be made of any material known in the art which exhibits the properties of a protective coating and is shrinkable by heat, e.g., a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, or mixtures or variations thereof. In preferred embodiments, the heat shrinkable material comprises polyvinyl chloride (PVC).

The heat shrinkable material will recover, or shrink down, to a smaller size when appropriate heat is applied. The thickness of the recovered heat shrinkable material depends upon the degree of recovery. For example, heat shrinkable material which is fully recovered will have a greater thickness than heat shrinkable material which is only partially recovered. Heat shrinkable material that has fully recovered can be half of the size or less of the material prior to sufficient heat exposure. With this in mind, the heat shrinkable material shrunken onto the hydrant marker is preferably of an appropriate thickness to protect the marker from the undesirable effects of daily exposure to the elements and environmental conditions. Thus, in preferred embodiments, the heat shrinkable material is from about 0.030 inches to about 0.100 inches thick after recovery and more preferably from about 0.030 to about 0.050 inches thick.

An adhesive agent may optionally be applied to either the portion of the hydrant marker to be covered with the heat shrinkable material, or to the heat shrinkable material itself prior to the application of the heat shrinkable material onto the marker. Any suitable multipurpose adhesive agent may be used, and one of skill in the art would recognize which multipurpose adhesives would be applicable for the methods describes herein.

The shrinking of the heat shrinkable material onto the marker not only provides protection for the hydrant marker, but also provides a smooth, aesthetically pleasing surface. To add to the cosmetic appearance of the protective covering, the heat shrinkable material used in the present invention may be clear or any particular color, depending on the user's preference. In certain embodiments, the heat shrinkable material used in the present invention may also be paintable. Additionally, the heat shrinkable material used may be high gloss, matte, metallic, neon or pearlescent, depending on the user's needs.

Many polymers may be degraded by UV light and pigments and dyes can absorb UV and change color. Therefore, in certain embodiments, the heat shrinkable material used in the present invention provides protection against UV light, which helps to maintain the durability and color of the hydrant marker.

The heat source used to shrink the heat shrinkable material may be any heat source known in the art capable of emitting sufficient heat to cause the heat shrinkable material to shrink onto the marker. Preferably, the temperature emitted from the heat source is from about 100° C. to about 2000° C. A preferred heat source for use in the present invention is a heat gun.

### EXAMPLE

### Example 1—Covering a Hydrant Marker

Heat shrinkable tubing, that is 20-40% larger in diameter than the hydrant marker to be covered, would be cut 1.0-2.0 in. longer than the length of the marker. The hydrant marker would be sprayed with a multipurpose adhesive**, then held vertically and the heat shrinkable tubing would be slid onto the marker.

Starting at the bottom of the hydrant marker, heat would be applied to the tubing with a heat gun. The heat shrinkable material would be pressed upwards towards the top of the hydrant marker to form a snug fit. The hydrant marker would be rotated throughout the process to ensure even melting of the heat shrinkable material.

The excess tubing would be trimmed away from the marker, and heat reapplied to provide a smooth surface.

**The multi-purpose adhesive spray is an optional step and not required for the heat shrinkable material to adhere onto the hydrant marker.

What is claimed:

1. A method of protecting and extending the useful life of hydrant markers comprising:
(a) contacting at least a portion of a hydrant marker with a heat shrinkable material;
(b) applying an effective amount of heat to said heat shrinkable material to shrink the heat shrinkable material onto the hydrant marker while maintaining the integrity of the hydrant marker.

2. The method of claim 1, further comprising trimming away excess heat shrinkable material after the heat shrinkable material has shrunken onto the hydrant marker.

3. The method of claim 1, wherein the heat shrinkable material is a flat sheet, tape or tubing.

4. The method of claim 1, wherein the heat shrinkable material comprises a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

5. The method of claim 1, wherein the heat shrinkable material comprises polyvinyl chloride.

6. The method of claim 1, wherein said heat shrinkable material comprises at least one additive selected from the group consisting of a colorant, a tackifier, a filler, a plasticizer, a processing oil, an antimicrobial agent, a ultraviolet (UV) curing agents, a magnetic/magnetisable material and mixtures thereof.

7. The method of claim 1, wherein said heat shrinkable material shrinks at a temperature of about 85° C. to about 200° C.

8. The method of claim 1, wherein said heat shrinkable material provides ultraviolet (UV) protection.

9. The method of claim 1, wherein the heat shrinkable material has a thickness of from about 0.030 to about 0.50 after recovery.

10. A hydrant marker comprising a heat shrinkable material surrounding at least a portion of the hydrant marker, wherein said heat shrinkable material has been exposed to an effective amount of heat to shrink the heat shrinkable material onto the hydrant marker.

11. The hydrant marker of claim 10, wherein said heat shrinkable material provides protection from damage of the hydrant marker.

12. The hydrant marker of claim 10, wherein the heat shrinkable material is in the shape of a flat sheet, tape or tubing prior to application to the hydrant marker.

13. The hydrant marker of claim 10, wherein the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

14. The hydrant marker of claim 10, wherein the heat shrinkable material comprises polyvinyl chloride.

15. The hydrant marker of claim 10, wherein said heat shrinkable material comprises at least one additive selected from the group a colorant, a tackifier, a filler, a plasticizer, a processing oil, an antimicrobial agent, a ultraviolet (UV) curing agents, a magnetic/magnetisable material and mixtures thereof.

16. The hydrant marker of claim 10, wherein said heat shrinkable material shrinks at a temperature of from about 85° C. to about 200° C.

17. The hydrant marker of claim 10, wherein said heat shrinkable material provides protection against ultraviolet (UV) light.

18. A method of beautifying and extending the useful life of a hydrant marker comprising:
(a) inserting at least a portion of a hydrant marker into a tubing comprising a polyvinyl chloride-based heat shrinkable material which provides protection against ultraviolet (UV) light; and
(b) exposing the heat shrinkable material to a heat source which causes the temperature of the heat shrinkable material to reach about 90° C. to about 110° C. to shrink the heat shrinkable material onto the hydrant marker while maintaining the integrity of the hydrant marker.
